(19) United States
(12) Patent Application Publication
(10) Pub. No.: US 2015/0019371 A1
(43) Pub. Date: Jan. 15, 2015

(54) SYSTEMS AND METHODS FOR SELECTING PARTS CONFIGURATIONS

(71) Applicant: Genuine Parts Company, Atlanta, GA (US)

(72) Inventors: Celena L. Evans, Atlanta, GA (US); Michael Gaffney, Atlanta, GA (US)

(21) Appl. No.: 14/329,071

(22) Filed: Jul. 11, 2014

Related U.S. Application Data
(60) Provisional application No. 61/845,432, filed on Jul. 12, 2013.

(51) Int. Cl. G06Q 30/06

(52) U.S. Cl. CPC G06Q 30/0621
USPC 705/26.5

(57) ABSTRACT

Techniques for suggesting suitable brake-pad and other automotive-part configurations, based on information including vehicle and/or driver characteristics. In some embodiments, the information can be received by a processor or computing device, such as an in-store kiosk, smartphone, or personal computer. The information can be obtained by prompting a consumer or electronically recovering information from a database or the vehicle itself. Responses to the prompts may be pre-populated based on known car configurations and estimated use profiles. A predetermined number of limited configurations may be suggested to ease consumer choice. One a selection is made, a scannable or machine-readable code may be generated to allow a user to recall their selection at another computing device.

### CROSS-REFERENCE TO RELATED APPLICATIONS

This Application claims priority and the benefit under 35 U.S.C. §119(e) of U.S. Provisional Patent Application No. 61/845,432, filed 12 Jul. 2013, of which the entire contents and substance are hereby incorporated by reference as if fully set forth below.

### TECHNICAL FIELD

The present invention relates generally to automotive parts, and more specifically, to systems and methods for automatically suggesting brake pad, and other configurations.

### BACKGROUND

A brake system is an essential component of a vehicle, with brake pads typically replaced every three to five years or 30,000 to 70,000 miles. About one in four vehicles will have a brake job in any given year according to the 2014 AAIA Digital Aftermarket Factbook. Over the average life of a vehicle, brake pads are replaced approximately three times. Moreover, “brake jobs” rank consistently in the top ten aftermarket vehicle repairs for vehicles four years and older.

In recent years, there has been a proliferation of auto parts stores and other sources offering aftermarket brakes in the $150 billion installer, or “do-it-for-me” (DIFM), business. The DIFM segment is approximately 3-4 times as large as the “do-it-yourself” (DIY) segment and growing at a higher rate. In addition, there is a proliferation of brands and product tiers. All of this competition, coupled with new channels of distribution (e.g., e-commerce) has driven increased price competition and brand erosion, so much that the DIFM brake pad market risks becoming commoditized.

A primary goal of many installers is avoiding undue consumer returns. The hyperactive state of the market for brake pads, however, has resulted in confusion with regard to selecting a quality brake pad that is appropriate for the application. The current confusion about brake pad selection is derived from, among other things:
Installers being inundated with marketing messages from brake pad suppliers and retailers, all making the same or similar claims (e.g., low/no noise, low/no dust, fit, etc.);
Increased variation in offering with regard to friction material, and other brake pad qualities; and
Complex and, at times, conflicting requirements for newer vehicle brake system designs.

Without clarity about the functionality and options with regard to brake pads, installer and consumer customers may default to non-performance related criteria for selecting/suggesting brake pads, including:
Experience with the brand;
Reputation of the retailer/distributor; and
Price.

What is needed, therefore, is a system and method to enable consumers to choose brake pads based on specific criteria. The system should enable the consumer to identify one or more brake pads (or other parts) that meet their criteria, while enabling the retailer to highlight new or targeted products. It is to such a system that embodiments of the present invention are primarily directed.

### SUMMARY

The customer experience can be improved by educating customers, both installers and end-consumers, about the performance of various automotive parts. This is particularly true in the flooded brake pad market where information regarding the true performance of available brake pad offerings can help to avoid commoditization of brake pads and brake pad installations. Accordingly, embodiments of the present invention can include systems and methods for automatically and intelligently suggesting brake pad, or other part, configurations. The suggested configurations can be prescribed based on a variety of vehicle and driver characteristics. Moreover, the suggested configurations can be presented in such a way as to educate customers by demonstrating differences in key attributes between competing products through quantifiable comparisons. As a result, certain embodiments can simplify selection of brake pads, or other products, by clearly delineating product features, benefits, and appropriate applications.

Other embodiments, features, and aspects of the present invention are described in detail herein and are considered a part of the claimed present invention. Other embodiments, features, and aspects may be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIGS. 1-3 depict conventional methods 100, 200, 300 for selecting brake pads.

FIGS. 4-7 depict user interfaces 400, 500, 600, 700 for collecting user responses to questions about vehicle and driver characteristics, according to some embodiments of the present invention.

FIG. 8 depicts a user interface 800 for presenting a suggested brake pad configuration, according to some embodiments of the present invention.

FIG. 9 depicts a block diagram 900 of illustrative computer system architecture, according to some embodiments of the present invention.

FIGS. 10-12 depict flow diagrams 1000, 1100, 1200 of methods for suggesting automotive-part configurations, according to some embodiments of the present invention.

### DETAILED DESCRIPTION

Embodiments of the present invention relate to a system and method for intelligently choosing auto parts and, in particular, brake pads. In some embodiments, the system can include a graphical user interface (GUI) and can provide the user with a series of questions. The system can then apply an algorithm to provide the user with one or more suggestions for a particular part. The algorithm can take in to account, for example and not limitation, customer preferences, performance specifications, cost, and sales preferences.

To simplify explanation, the system is described below as a system and method for selecting brake pads. One skilled in the art will recognize, however, that the invention is not so limited. The system can also provide improved selection of a variety of auto parts including, but not limited to, oil, filters, shock absorbers, suspension components, and brake rotors, and drums. The system can also provide suggestions, for example, for performance upgrades or other aftermarket products.

To facilitate an understanding of the principles and features of embodiments of the present invention, various example embodiments are explained below. In particular, certain embodiments of the invention are described in the context of being an automated system providing intelligent brake pad suggestions based on vehicle and driver characteristics. Embodiments of the invention, however, are not so limited. Rather, various aspects of the present invention can apply to the intelligent selection and configuration of other automotive products and systems.

Further, in describing the example embodiments, specific terminology will be resorted to for the sake of clarity. It is not intended that the present invention be limited in scope to the details of construction and arrangement of components set forth in the following description or illustrated in the drawings. Rather, the present invention is capable of other embodiments and of being practiced or carried out in various ways.

Throughout the specification and the claims, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or.” Further, the terms “a,” “an,” and “the” are intended to mean one or more unless specified otherwise or clear from the context to be directed to a singular form. The term “include” and its various forms are intended to mean including but not limited to.

Referring now to the figures, in which like reference numerals represent like parts throughout the views, various embodiments of the disclosed technology will be described in detail.

### Overview

The hydraulic braking system is a crucial automotive technology. Brake pads or shoes are acted on with hydraulic pressure to contact brake rotors or drums, respectively, to create friction and stop the vehicle. The brake system essentially converts the vehicle's kinetic energy into heat to stop the vehicle. Due to the sophistication of modern vehicles, and indeed modern drivers, it is important that the pads and rotors, for example, be carefully chosen to meet a vehicle's specifications. This is important to prevent, for example, failure related to overheating, excess brake dust, and to minimize noise, vibration, and harshness (NVH).

Brake pads generally consist of a steel backing plate with a layer of friction material bonded to one side. Because the pads can be manufactured with relatively inexpensive materials, and because the market is large, there has been a proliferation of brake pad manufacturers that range widely in cost, quality, and materials. Organic brake pads, for example, can provide quiet operation at the expense of excessive dust and reduced pad life. Metallic brake pads, on the other hand, can provide increased pad life and braking power at the expense of rotor life and excessive dust. Ceramic pads are relatively new to the market and provide good life and lighter colored, if not necessarily reduced, dust making the dust less visible.

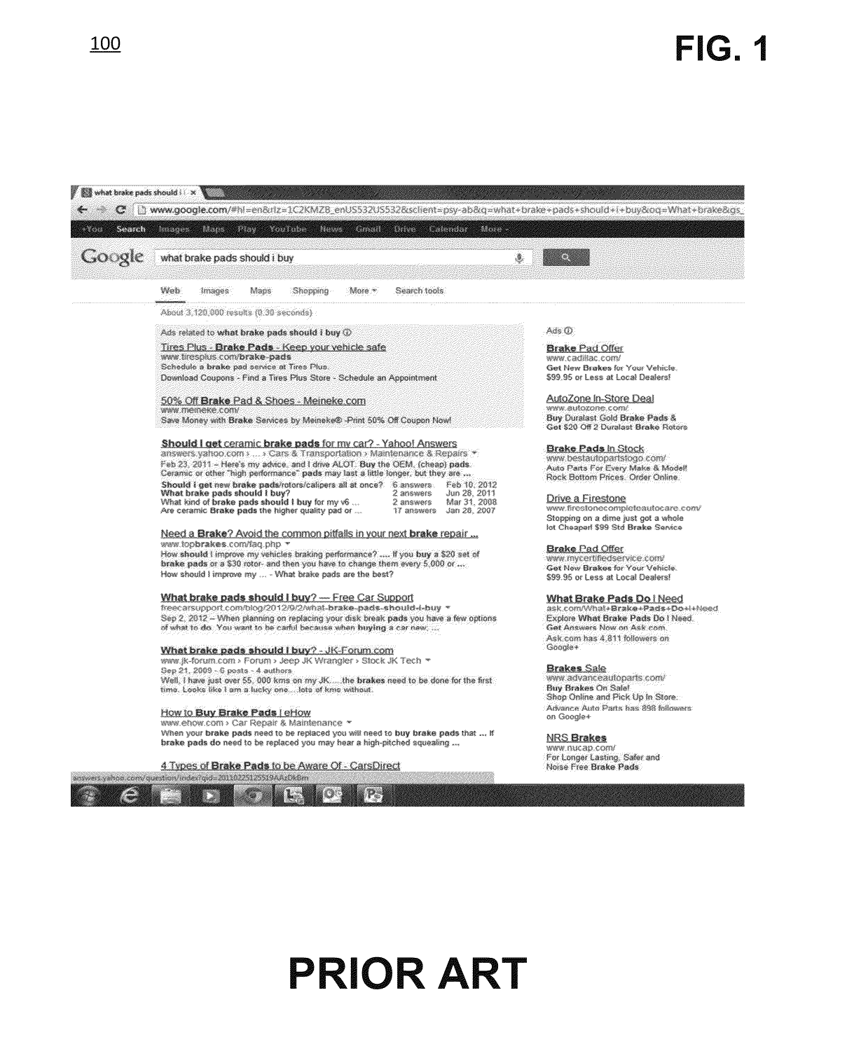

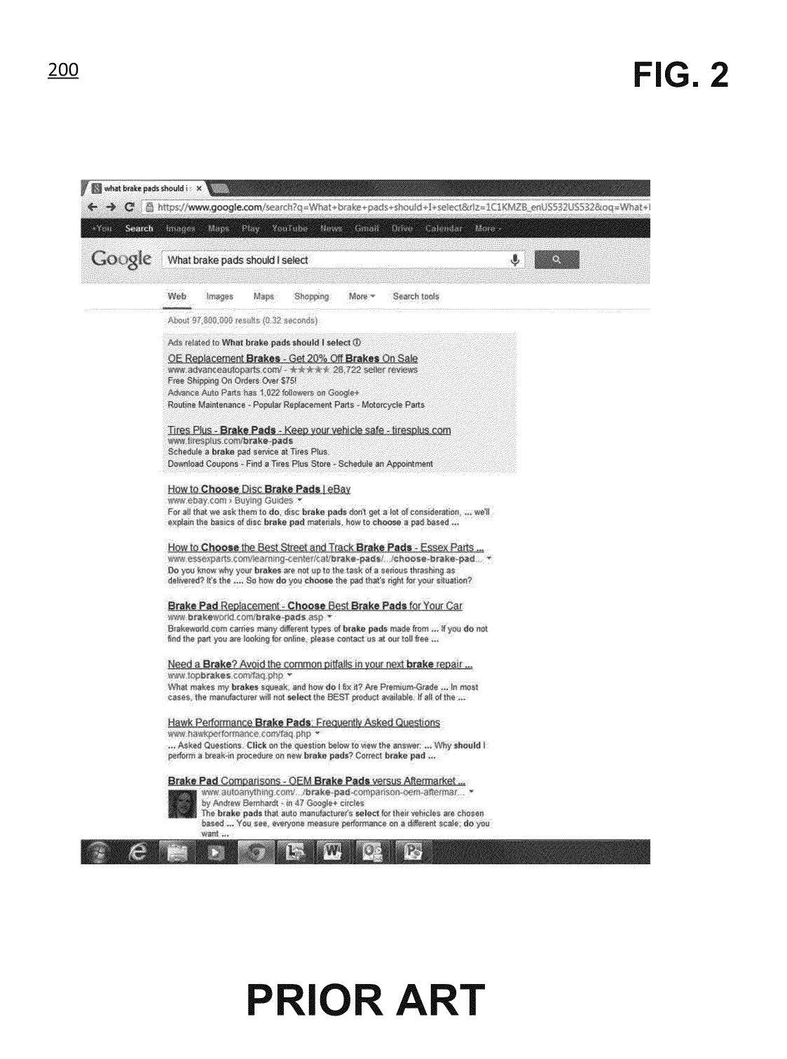

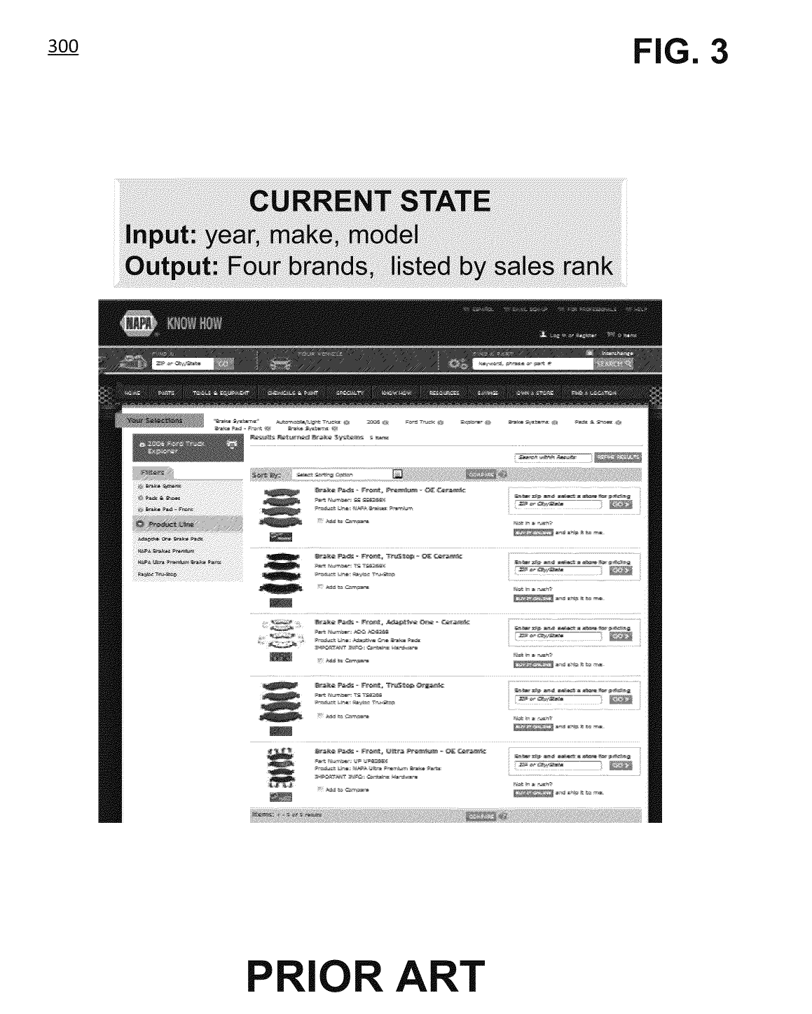

As shown in FIGS. 1-3, conventional methods for selecting brands and types of brake pads include using unwieldy search engines and poorly organized product pages to identify products based on limited vehicle information, if any. The search interface shown in FIG. 3, for example, considers only the vehicle year, make, and model, but does not account for important factors such as the driving style of the vehicle's owner or operator, or even the driving environment of the vehicle, itself. Moreover, the returned search results may be, at best, a generic list of products ordered by a non-performance oriented criteria, such as price.

In contrast, embodiments of the present invention include an intelligent brake pad selection tool that can suggest brake pad configurations based on both vehicle and driver characteristics. The selection tool can improve the customer experience by lessening or eliminating the guesswork from selecting brake pads, and providing a consistent and transparent shopping experience for consumers. This can foster long-term customer loyalty and satisfaction and help differentiate brake pads and installers in an increasingly commoditized market.

Some goals of the present invention include, but are not limited to, empowering consumers with:
Awareness that they do have a choice in brake pads;
Awareness that different pads and pad materials have noticeably different characteristics;
Knowledge of the general differences in brake pads; and
Confidence that the right brake pads for their needs were selected and installed on their vehicle.

### Selection Tool Use

The selection tool can be used by a counterperson or service technician with a consumer at a store or shop, or by the consumer alone at their leisure. In some embodiments, an in-store technician (e.g., parts counter employee) may interact with a consumer and enter information into the selection tool based on consumer responses. In other embodiments, the selection tool can be accessed from an in-store kiosk where consumers can approach and make use of the system. A technician or sales-person can optionally walk through the system with the user or provide assistance as needed.

In still other embodiments, the selection tool can be downloaded or accessed remotely by a customer with a computer, smart phone, or other device, in advance of visiting a store or shop. The selection tool can provide an indication of a user session with the selection tool, for example, and a print-out of the suggested products, which the user can bring to a store or shop. The print-out may have a scannable or machine-readable code (e.g. 2D or 3D barcode) or other feature that enables the user to access information that was entered at home, later, at a remote kiosk, for example, in an auto-parts store. In yet another embodiment, the selection tool can provide an option to save a session on a portable media device, or upload the session for later download and access. Thus, a user can begin a session with the selection tool at a first time in a first location, and continue the session at another time or in another location.

### Selection Tool Operation

The selection tool can suggest brake pad configurations based on vehicle and driver characteristics. The selection tool can collect various vehicle characteristics, including, for example and not limitation, the year, make, model, mileage, condition of current brake pad configuration, etc. Driver characteristics can include various criteria, for example: satisfaction and future plans (i.e., satisfaction with current installed product and plans to keep the vehicle); vehicle use and care (e.g., driving environment, concern about appearance, towing/heavy loads, adherence to maintenance schedules, etc.); driving style, (e.g., aggressiveness, type of braking, etc.); and driver lifestyle (e.g., tendency to accept advanced technology or do-it-yourself, desired price vs. performance tradeoff).

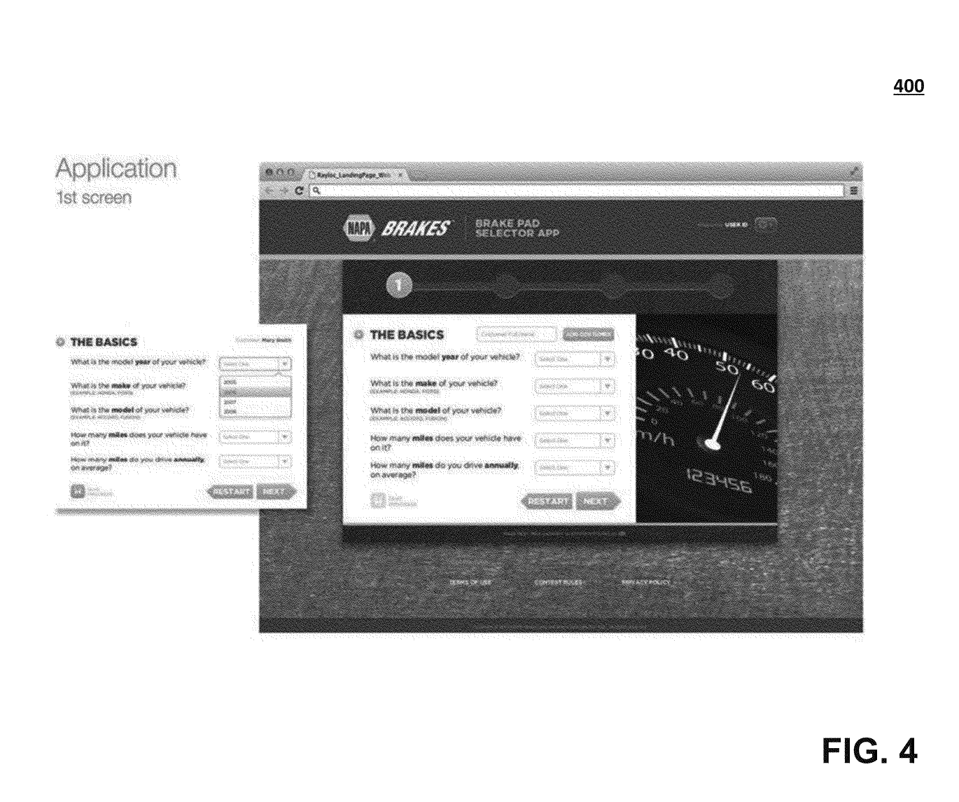

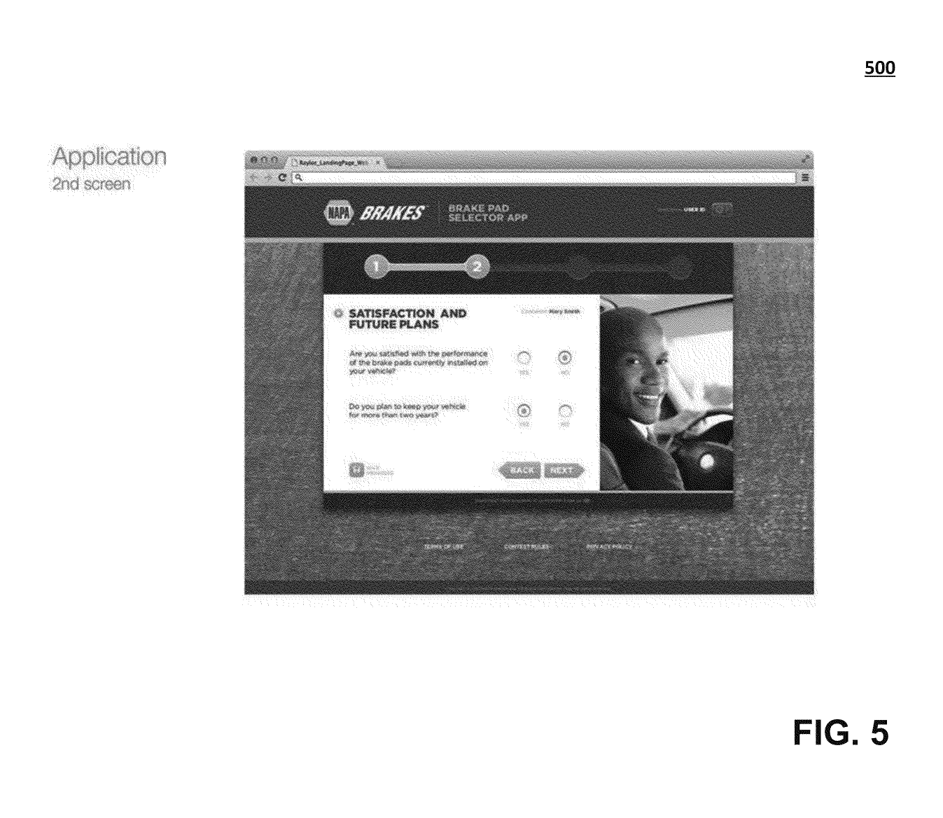

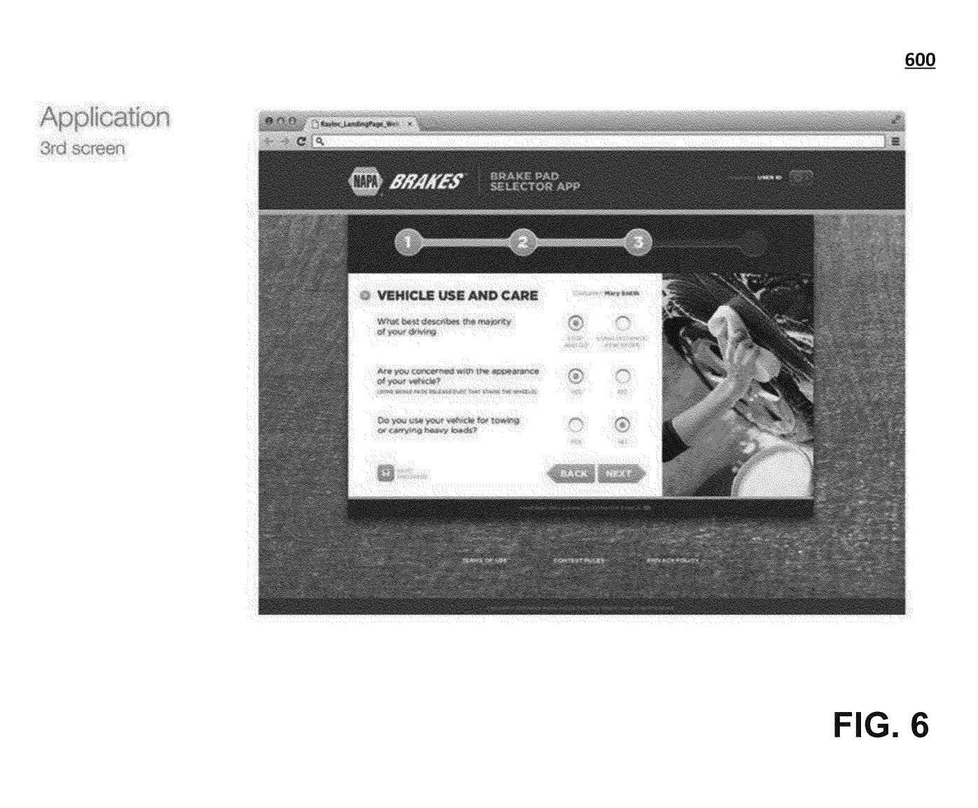

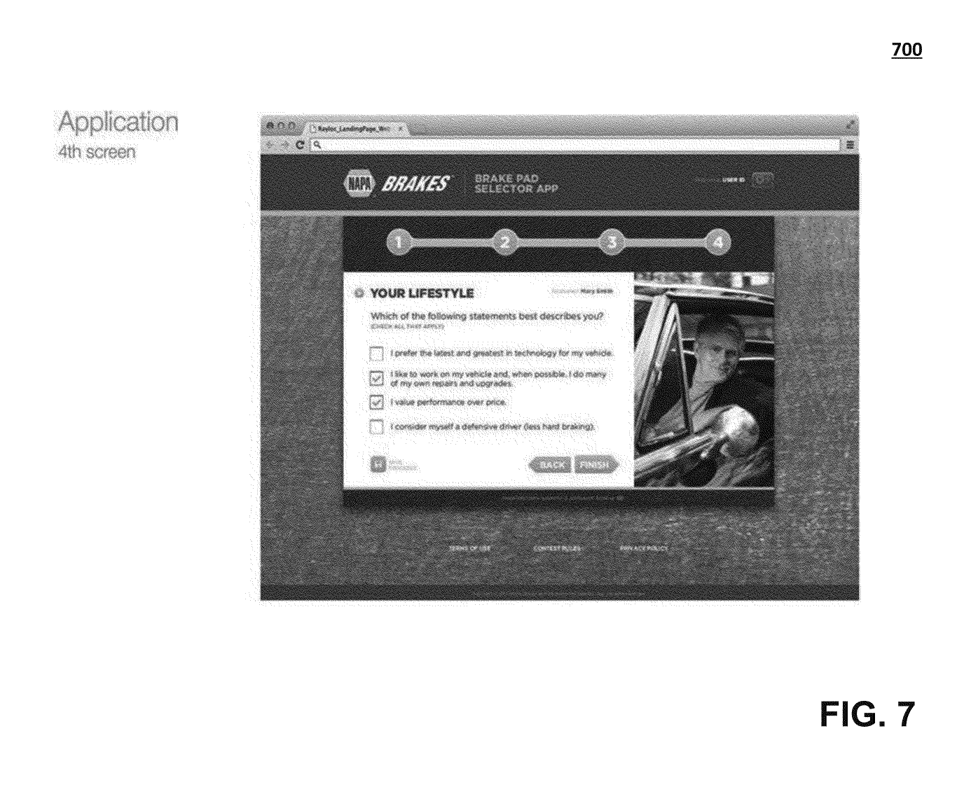

In some embodiments, these characteristics can be at least partially self-reported by the consumer. The selection tool can present questions to a user, for example, to discern vehicle or driver characteristics. FIGS. 4-7 depict user interfaces for collecting user responses to questions about vehicle and driver characteristics, according to some embodiments of the present invention.

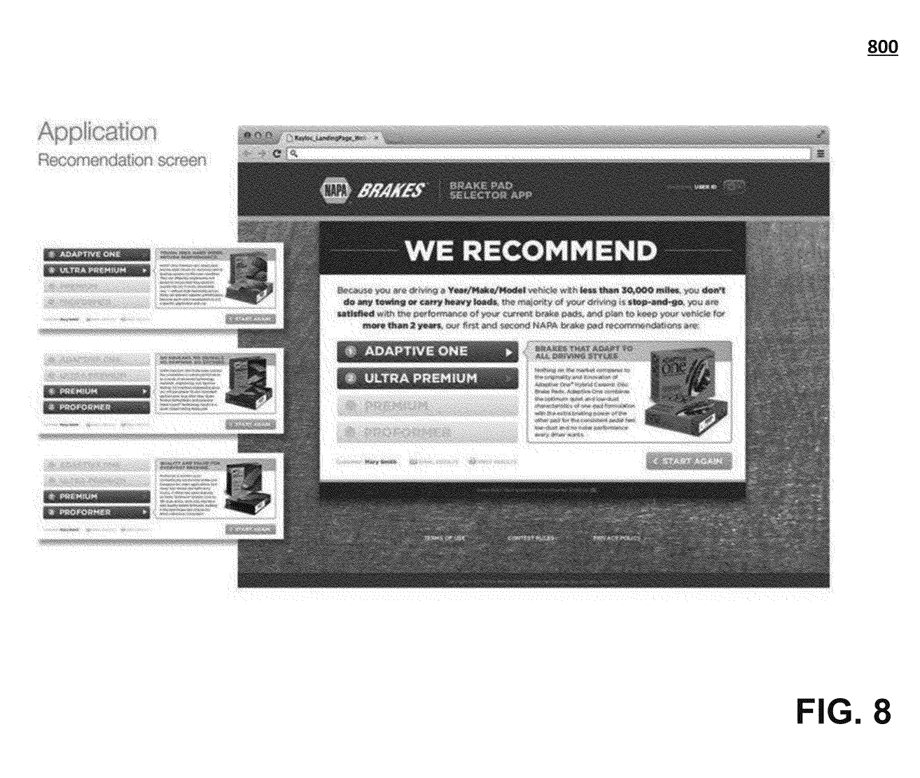

As shown in FIGS. 4-7, the selection tool may prompt a user to select between a limited number of options in response to a question, in order to help keep the experience engaging, yet simple, clear, and not overly technical. Limiting the number of presented options can empower a user to make a choice, while increasing the likelihood that a suitable product is available. Moreover, a small number of options can create the impression of transparency, enhancing the customer experience. In some embodiments, as shown in FIG. 8, the final brake pad recommendation can be limited to a relatively small number of options (e.g., two to three). In a preferred embodiment, each option is a legitimate, catalogued item that fits the customer's car and needs.

In other embodiments, one or more characteristics may also be read from a computer or other system of the vehicle (e.g., OBD-II), or imported from a database based on an identifier associated with the car (e.g., the VIN) or consumer. In still other embodiments, information already known about a vehicle may be pre-populated or suggested, for example, for a vehicle associated with a repeat consumer, or based on known available car configurations. So, for example, if a vehicle is only available with an eight-cylinder engine or an automatic transmission, this information can be pre-populated by the system.

Moreover, in some embodiments, the selection tool can make intelligent guesses about vehicle characteristics, for example, populating an estimated mileage based on the year of the vehicle. Even though a vehicle's actual characteristics may differ from the pre-populated value, pre-populating data can illustrate the proper format for entering data and provide a convenient starting point to facilitate data entry.

A brake pad configuration can be suggested based on the user responses and selections. In some embodiments, there can be a point matrix associated with each user input. As the respondent answers each question, for example, points can be assigned based on the matrix to a category or grouping of brake pads including, for example, the type of pad (e.g., metallic vs. organic) or the brand. After some or all relevant questions have been answered, the points can be tallied to determine one or more top scoring, or recommended, brands. In some embodiments, however, exceptions or special rules may be applied based on, for example, the age and price point of the vehicle, retailer stock, or new products. An economy car older than fifteen, for instance, may automatically have less expensive products (e.g., Premium and Proformer) as its recommendations. Moreover, users with identical responses may value the same criteria differently. Accordingly, in some embodiments, the responses to certain questions can be weighted. One of skill in the art will recognize other suitable methods of calculating questionnaire scores to provide a recommendation. Such methods are considered and within the scope of the present invention.

FIG. 8 depicts a user interface for presenting a suggested brake pad configuration, according to some embodiments. Ultimately, the questions and selections presented by the selection tool should not only enlighten the consumer, but also foster a perception of completeness and thoroughness of the assessment. Thus, in some embodiments, the recommendation screen can list the recommended brands or products, while also reiterating the inputs (e.g., responses to questions) that led to that suggestion. In other embodiments, the selection tool can provide a brief positioning statement about the recommended brands or products.

### Example Systems

Various embodiments of the present invention may be embodied in non-transitory computer readable media for execution by one or more processors. Some embodiments may be used in an application of a computing device, such as a smartphone or tablet, but other computing devices, including non-portable computing devices, may also be used.

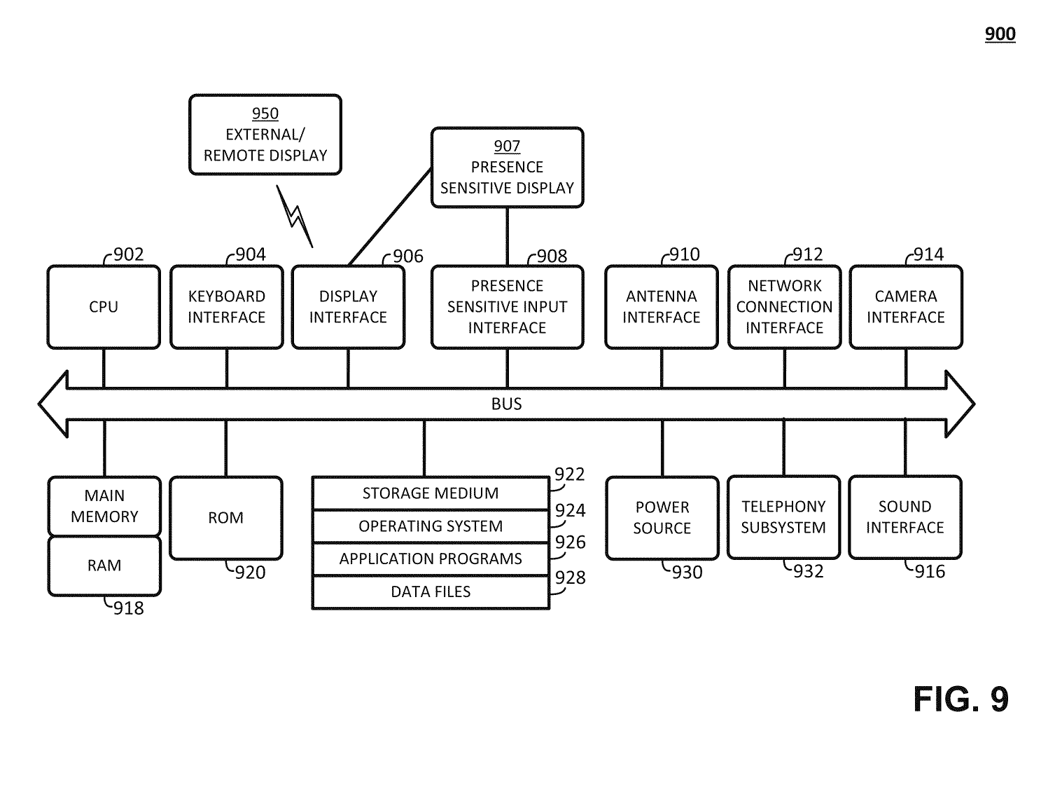

FIG. 9 depicts a block diagram of illustrative computer system architecture, according to some embodiments. Certain aspects of the present invention, for example, the selection tool, may be embodied in a computing device. As desired, embodiments of the disclosed technology may include a computing device with more or less of the components illustrated in FIG. 9. It will be understood that the architecture is provided for example purposes only and does not limit the scope of the various embodiments of the systems and methods for measuring and rewarding activity levels.

The architecture 900 of FIG. 9 includes a central processing unit (CPU) 902, where computer instructions are processed; a display interface 906 that acts as a communication interface and provides functions for rendering video, graphics, images, and texts on the display; a keyboard interface 904 that provides a communication interface to a keyboard; and a pointing device interface 908 that provides a communication interface to a pointing device, e.g., a touchscreen or presence-sensitive screen 907. Some embodiments of the architecture may include an antenna interface 910 that provides a communication interface to an antenna. Some embodiments may also include a connection interface. The connection interface may include one or more of a peripheral connection interface and network communication interface 912, providing a communication interface to an external device or network. In some embodiments, a camera interface 914 may be provided to act as a communication interface and provides functions for capturing digital images from a camera. In certain embodiments, a sound interface 916 may be provided as a communication interface for converting sound into electrical signals using a microphone and for converting electrical signals into sound using a speaker. In some embodiments, a random access memory (RAM) 918 may be provided, where computer instructions and data may be stored in a volatile memory device for processing by the CPU.

In some embodiments, the architecture may include a read-only memory (ROM) 920 where invariant low-level system code or data for basic system functions such as basic input and output (I/O), startup, or reception of keystrokes from a keyboard are stored in a non-volatile memory device. According to an some embodiments, the architecture may include a storage medium 922 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 924, application programs 926 (including, for example, a web browser application, a widget or gadget engine, and or other applications, as necessary) and data files 928 are stored. In some embodiments, the architecture may include a power source 930 that provides an appropriate alternating current (AC) or direct current (DC) to power components. In other embodiments, the architecture may include a telephony subsystem 932 that allows the device to transmit and receive sound over a telephone network. The constituent devices and the CPU may communicate with each other over a bus.

In some embodiments, the CPU 902 may have appropriate structure to be a computer processor. In one arrangement, the computer CPU may include more than one processing unit. The RAM 918 may interface with the computer bus to provide quick RAM storage to the CPU during the execution of computing programs such as the operating system application programs, and device drivers. More specifically, the CPU may load computer-executable process steps from the storage medium or other media into a field of the RAM in order to execute computing programs. Data may be stored in the RAM, where the data may be accessed by the computer CPU during execution. In one example configuration, the device may include at least 128 MB of RAM, and 256 MB of flash memory.

The storage medium 922 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media may allow the device to access computer-executable process steps, application programs and the like, stored on removable and non-removable memory media, to off-load data from the device or to upload data onto the device. A computer program product, such as one utilizing a communication system may be tangibly embodied in storage medium, which may comprise a machine-readable storage medium.

In some embodiments, the computing system architecture 900 may include any number of hardware and/or software applications that are executed to facilitate any of the operations. In other embodiments, one or more I/O interfaces may facilitate communication between the device computing system architecture and one or more input/output devices. For example, a universal serial bus port, a serial port, a disk drive, a CD-ROM drive, and/or one or more user interface devices, such as a display, keyboard, keypad, mouse, control panel, touchscreen display, microphone, etc., may facilitate user interaction with the device computing system architecture. The one or more I/O interfaces may be utilized to receive or collect data and/or user instructions from a wide variety of input devices. Received data may be processed by one or more computer processors as desired in various embodiments of the present invention and/or stored in one or more memory devices.

### Example Methods

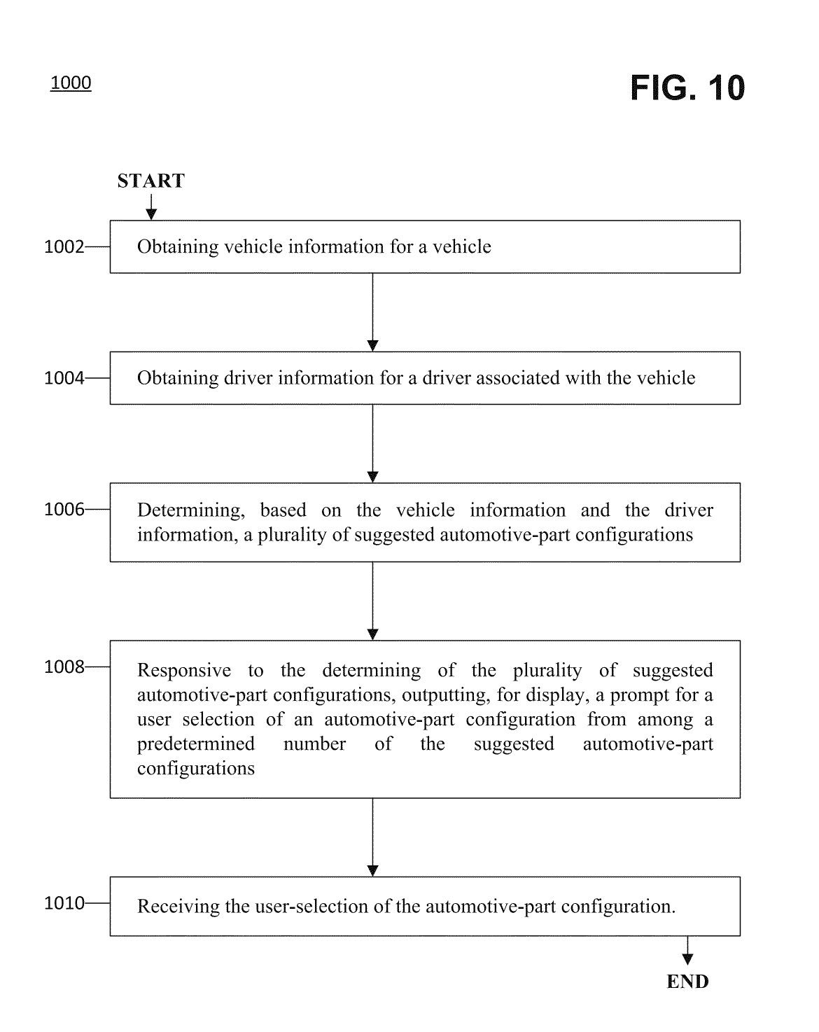

FIG. 10 is a flow diagram of a method 1000 for suggesting automotive-part configurations. As shown in FIG. 10, the method 1000 starts in block 1002, and, according to an example embodiment, includes obtaining vehicle information for a vehicle. In block 1004, the method 1000 includes obtaining driver information for a driver associated with the vehicle. In block 1006, the method 1000 includes determining, based on the vehicle information and the driver information, a plurality of suggested automotive-part configurations. In block 1008, the method 1000 includes responsive to the determining of the plurality of suggested automotive-part configurations, outputting, for display, a prompt for a user selection of an automotive-part configuration from among a predetermined number of the suggested automotive-part configurations. In block 1010, the method 1000 includes receiving the user-selection of the automotive-part configuration.

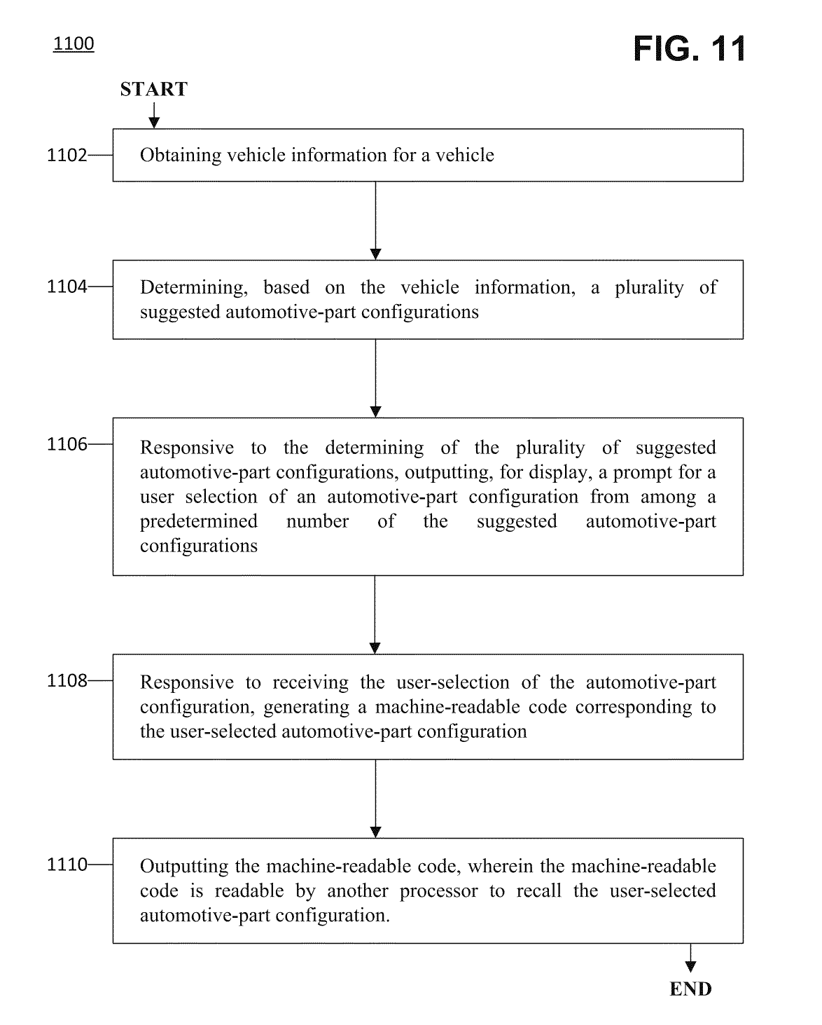

FIG. 11 is another flow diagram of a method 1100 for suggesting automotive-part configurations. As shown in FIG. 11, the method 1100 starts in block 1102, and, according to an example embodiment, includes obtaining vehicle information for a vehicle. In block 1104, the method 1100 includes determining, based on the vehicle information, a plurality of suggested automotive-part configurations. In block 1106, the method 1100 includes, responsive to the determining of the plurality of suggested automotive-part configurations, outputting, for display, a prompt for a user selection of an automotive-part configuration from among a predetermined number of the suggested automotive-part configurations. In block 1108, the method 1100 includes, responsive to receiving the user-selection of the automotive-part configuration, generating a machine-readable code corresponding to the user-selected automotive-part configuration. In block 1110, the method 1100 includes outputting the machine-readable code, wherein the machine-readable code is readable by another processor to recall the user-selected automotive-part configuration.

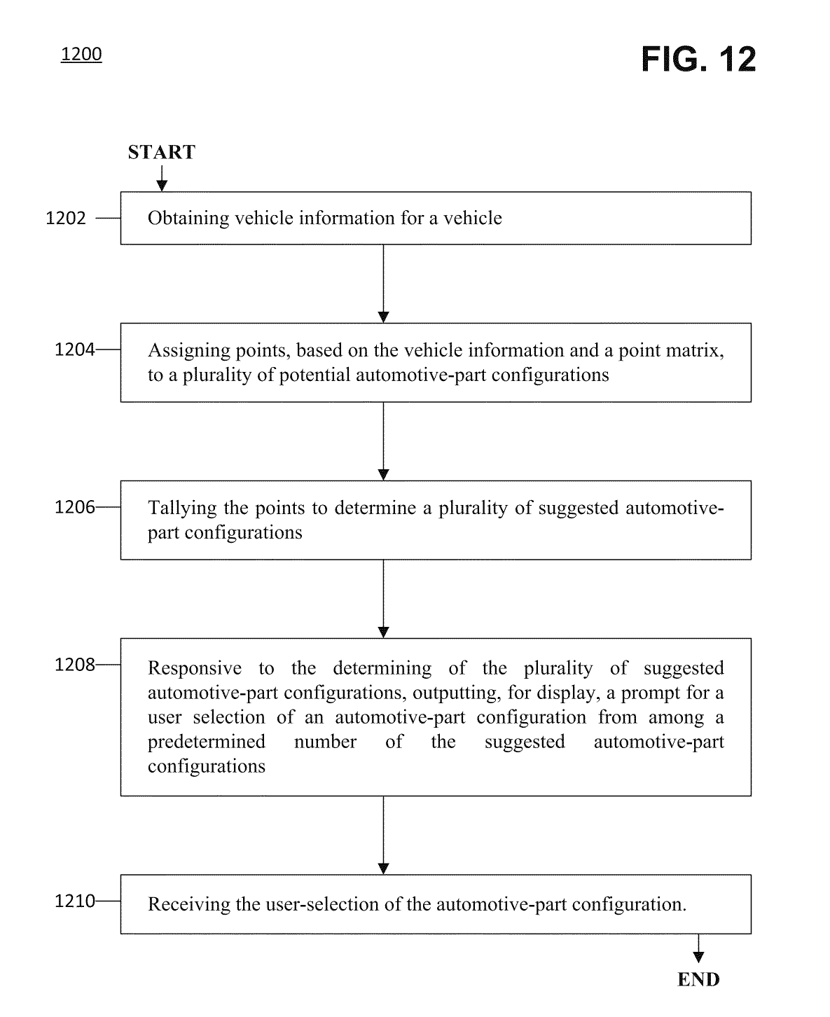

FIG. 12 is yet another flow diagram of a method 1200 for suggesting automotive-part configurations. As shown in FIG. 12, the method 1200 starts in block 1202, and, according to an example embodiment, includes obtaining vehicle information for a vehicle. In block 1204, the method 1200 includes assigning points, based on the vehicle information and a point matrix, to a plurality of potential automotive-part configurations. In block 1206, the method 1200 includes tallying the points to determine a plurality of suggested automotive-part configurations. In block 1208, the method 1200 includes, responsive to the determining of the plurality of suggested automotive-part configurations, outputting, for display, a prompt for a user selection of an automotive-part configuration from among a predetermined number of the suggested automotive-part configurations. In block 1210, the method 1200 includes receiving the user-selection of the automotive-part configuration.

Certain embodiments of the present invention are described above with reference to block or flow diagrams of systems and methods and/or computer program products according to some embodiments of the present invention. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some embodiments of the present invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that may direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

What has been described and illustrated herein is a preferred embodiment of the invention along with some of its variations. The terms, descriptions, and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

While certain embodiments of the present invention have been described in connection with what is presently considered to be the most practical and various embodiments, it is to be understood that the present invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose some embodiments of the present invention, including the best mode, and also to enable any person skilled in the art to practice these embodiments of the present invention, including making and using any devices or systems and performing any incorporated methods. The patentable scope of certain embodiments of the present invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for suggesting automotive part configurations, comprising:
obtaining vehicle information for a vehicle;
obtaining driver information for a driver associated with the vehicle;
determining, by a computing device, based on the vehicle information and the driver information, a plurality of suggested automotive part configurations;
responsive to the determining of the plurality of suggested automotive part configurations, outputting, for display, a prompt for a user selection of an automotive part configuration from among a predetermined number of the suggested automotive part configurations; and
receiving the user selection of the automotive part configuration.

2. The method of claim 1, wherein the vehicle information is obtained from a human user, the method further comprising outputting, for display, a user prompt for vehicle information.

3. The method of claim 2, the method further comprising suggesting a pre populated response to the user prompt, wherein the pre populated response is based on known available car configurations.

4. The method of claim 2, the method further comprising suggesting a pre populated response to the user prompt, wherein the pre populated response is based on an estimated use profile for the vehicle.

5. The method of claim 1, wherein the vehicle information is obtained electronically from a vehicle.

6. The method of claim 5, wherein the vehicle information is electronically collected from an on board diagnostics system of the vehicle.

7. The method of claim 5, wherein the vehicle information is collected from an electronic database based on an identifier associated with the vehicle or the driver.

8. A computer program product comprising a non-transitory computer readable medium that stores instructions that, when executed by a processor, cause the processor to perform a method for suggesting automotive part configurations, comprising:
obtaining vehicle information for a vehicle;
determining, by the computing device, based on the vehicle information, a plurality of suggested automotive part configurations;
responsive to the determining of the plurality of suggested automotive part configurations, outputting, for display, a prompt for a user selection of an automotive part configuration from among a predetermined number of the suggested automotive part configurations;
responsive to receiving the user selection of the automotive part configuration, generating a machine readable code corresponding to the user selected automotive part configuration; and
outputting the machine readable code, wherein the machine readable code is readable by a processor to recall the user selected automotive part configuration.

9. The computer program product of claim 8, wherein the machine readable code is generated at a mobile or personal processor associated with an automotive part consumer, and the machine readable code is scannable at a location associated with an automotive part installer.

10. The computer program product of claim 8, wherein the predetermined number of the suggested automotive part configurations is selected from the plurality of suggested automotive part configurations at least partially based on an availability of the plurality of suggested automotive part configurations at an associated automotive part installer.

11. The computer program product of claim 8, wherein the predetermined number of the suggested automotive part configurations is selected from the plurality of suggested automotive part configurations at least partially based on an age of the vehicle.

12. The computer program product of claim 8, further comprising outputting, for display with the predetermined number of the suggested automotive part configurations, an indication of the vehicle information.

13. The computer program product of claim 8, wherein the predetermined number of the suggested automotive part configurations is three suggested automotive part configurations.

14. A system, comprising:
a processor;
a memory operatively coupled to the processor and configured for storing data and instructions that, when executed by the processor, cause the system to perform a method for suggesting automotive part configurations, comprising:
obtaining vehicle information for a vehicle;
assigning points, based on the vehicle information and a point matrix, to a plurality of potential automotive part configurations;
tallying the points to determine a plurality of suggested automotive part configurations;
responsive to the determining of the plurality of suggested automotive part configurations, outputting, for display, a prompt for a user selection of an automotive part configuration from among a predetermined number of the suggested automotive part configurations; and
receiving the user selection of the automotive part configuration.

15. The system of claim 14, the method further comprising obtaining driver information associated with a driver of the vehicle.

16. The system of claim 15, wherein the driver information includes at least one of driving style, vehicle care, vehicle use, price and performance sensitivity, satisfaction with current configuration, and future plans.

17. The system of claim 15, wherein the automotive part configuration includes a brake pad configuration, and wherein the driver information reflects one or more of aggressiveness and a type of braking.

18. The system of claim 14, wherein each of the predetermined number of the suggested automotive part configurations is a catalogued item with an associated installer.

19. The system of claim 14, wherein the predetermined number of the suggested automotive part configurations is two suggested automotive part configurations.

20. The system of claim 14, wherein the vehicle information includes one or more of a year, make, model, mileage, and condition of current brake pad configuration.
